(19) United States
(12) Patent Application Publication
(10) Pub. No.: US 2011/0022289 A1
(43) Pub. Date: Jan. 27, 2011

(54) METHOD OF CONTROLLING AN ELECTRICALLY ASSISTED TURBOCHARGER

(75) Inventor: Peter Hofbauer, West Bloomfield, MI (US)

Correspondence Address: PAUL K. GODWIN;Paul K. Godwin, P.C., 7218 Pine Vista Dr., Brighton, MI, 48116, US

(73) Assignee: EcoMotors International, Inc., Troy, MI (US)

(21) Appl. No.: 12/843,012

(22) Filed: Jul. 24, 2010

Related U.S. Application Data
(60) Provisional application No. 61/271,844, filed on Jul. 27, 2009.

(51) Int. Cl. F02D 41/00; F02B 33/00; F02M 25/07

(52) U.S. Cl. 701/103; 123/565; 123/568.11

(57) ABSTRACT

Suitable for retrofitting conventional turbo charged engines, an electrically controlled turbocharger is installed in a Compression Ignition Direct Injection (CIDI) Engine and controlled to maintain a predetermined optimal air/fuel ratio throughout the operating range of the engine. Electrical energy is applied to the motor/generator of the turbocharger to boost its operation when the engine is being operated at relatively low speeds or under high torque loads and the engine exhaust gases applied to the turbine are insufficient to drive the turbocharger to maintain the predetermined air/fuel ratio. Electrical energy is produced by the motor/generator of the turbocharger when the engine is being operated at higher speeds and the engine exhaust gases applied to the turbine are excessive in driving the turbine to maintain the predetermined air/fuel ratio. By capturing the electrical energy produced by the motor/generator and adjusting the load, the turbine is slowed down to maintain the predetermined air/fuel ratio.

### PRIORITY

Priority is claimed for provisional application U.S. 61/271,844, filed Jul. 27, 2009.

### RELATED APPLICATIONS

This application is related to commonly assigned non-provisional application U.S. Ser. No. 12/417,568 filed Apr. 2, 2009, US Pub 2010-0175377; non-provisional application U.S. Ser. No. 12/791,832 filed Jun. 1, 2010; and to PCT/US/10/20707 filed Jan. 12, 2010 publication WO-2010081123, all of which are incorporated herein by reference.

### FIELD

This invention relates to electrically assisted turbochargers and more specifically to the electrical control of such turbochargers throughout the range of operation to obtain predetermined air/fuel (“A/F”) ratio(s) over the operating range of an associated internal combustion engine.

### SUMMARY

An electrically assisted turbocharger (“EAT”) comprises a conventional exhaust gas driven turbocharger configured with a modified center housing and shaft to facilitate the location and operation of a built-in electric motor. The EAT is also termed herein as an electrically controlled turbocharger (“ECT”). The electric motor, along with its associated controller provide for the application or extraction of electrical energy to/from the turbocharger over its operating range. The disclosed embodiment controls both intake pressure and exhaust pressure at all operating points of the engine within its operating range.

While the related applications referenced above are generally directed to the construction of electrically controlled turbochargers, the disclosed embodiment deals with the control methodology used to regulate the rotation of the turbine and compressor of the turbocharger for optimal fuel efficiency by maintaining the A/F ratio at an optimal range over the operating range of the associated internal combustion engine. In particular, an A/F ratio is selected that provides relatively high fuel efficiency, as well as low NOx and low particulate emissions.

The disclosed embodiment is directed to improvements in controlling the electric motor used in an ECT turbocharger that operates over a wide range of speeds from the very low at engine idle to significantly high speeds, in the range of approximately 200,000 rpms and above.

### BRIEF DESCRIPTION OF THE DRAWINGS

FIG. 1 is a schematic drawing of an internal combustion engine system employing the disclosed embodiment.

FIG. 2 is an example of a plot of A/F ratio vs. fuel consumption from an internal combustion engine.

FIG. 3 is a plot of percentage of exhaust gas recirculation ratio vs. A/F ratio, on the left axis, vs. electrical power applied to and received from the electrical motor of an electrically assisted turbocharger, on the right axis.

FIG. 4 is a plot of percentage of exhaust gas recirculation ratio vs. mass flow, on the left axis, vs. electrical power applied to and received from the electrical motor of an electrically assisted turbocharger, on the right axis.

FIG. 5 is a representation various contributions of fuel, fresh air, excess lean air, as well as recirculated air and inert gas recirculated through EGR by their respective mass contributions in the cylinder.

FIG. 6 is a comparison of the various masses in cylinder before combustion for conventional turbocharger and ECT, at equivalent EGR, and at equivalent A/F ratio.

FIG. 7 is a comparison the various masses in cylinder before combustion for the ECT being operated at equivalent EGR, and at equivalent optimal A/F ratio.

### DETAILED DESCRIPTION

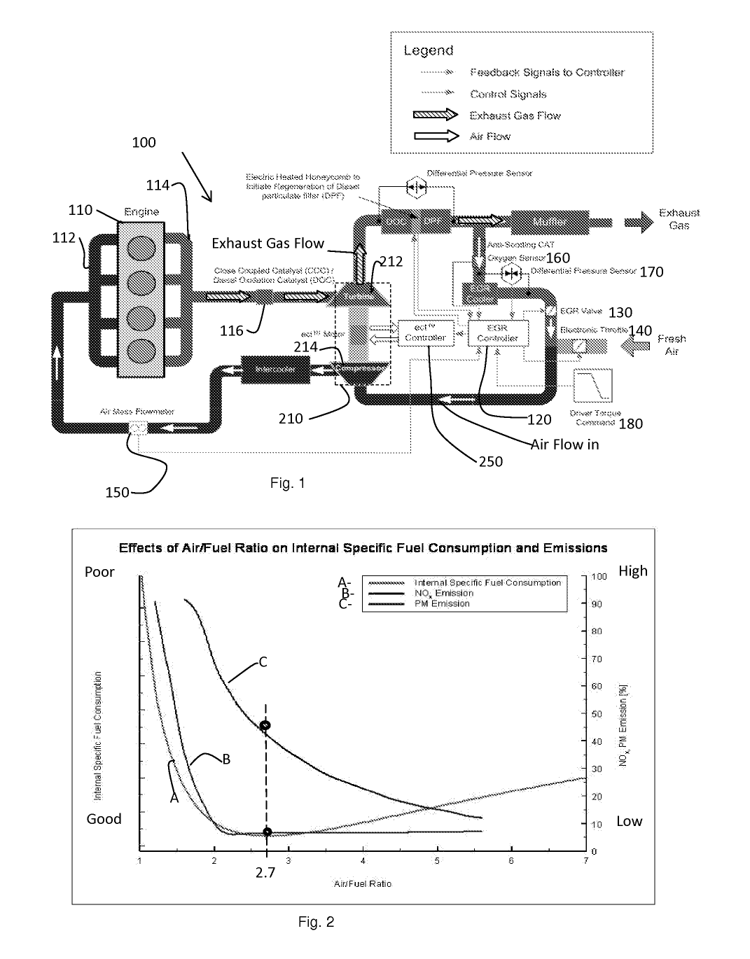

FIG. 1 illustrates an ETC of the disclosed embodiment retrofitted into a conventionally turbocharged compression ignition direct injection (CIDI) engine system 100. The disclosed embodiment comprises an ECT 200 and its controller 210. The ETC 200 is coupled with a Low Pressure Loop (LPL) Exhaust Gas Recirculation (“EGR”) system and its controller 120. Along with various sensors and actuators, the ETC 210 achieves drastic improvements in emissions at all engine operating points as described below.

At the heart of the system is the ECT 210 and its power electronics controller 250. The ECT 210 functions in tandem with the EGR valve 130 and Electronic Throttle 140 to implement the control strategies herein. Both the EGR Valve 130 and Electronic Throttle 140 are selected from commercially available components and are controlled by an EGR controller 120. An off-the-shelf programmable engine ECU may be used for this purpose because of its ability to control systems using existing protocols such as CAN buss and it's robust, vehicle ready design. EGR controller 120 receives input signals from an intake Air Mass Flowmeter 150, EGR Oxygen Sensor 160, EGR Cooler Differential Pressure Sensor 170, and Driver Torque Command 180. A control algorithm processes this information and provides input signals to ECT controller 250, EGR Valve 130, and Electronic Throttle 140.

Also included in the System 100 are various catalysts to reduce emissions as well as to protect the EGR cooler from becoming clogged with soot. The Close Coupled Catalyst (CCC), Diesel Oxidation Catalyst (DOC), and Soot CAT are commercially available components adapted into the system.

Diesel engines have long been plagued by poor emissions. Applicants have discovered that by staging multiple injections, by using high levels of Exhaust Gas Recirculation (EGR) and through intake manifold temperature control, it is possible to operate in the area of low temperature combustion (LTC). Specifically, by maintaining combustion temperatures below 2000° K (˜1750° C.) low NOx are generated. Further control of LTC can generate a reducing exhaust rich injection so that the Lean NOₓ Trap (LNT) can be regenerated less often. To shift the combustion from conventional to lower temperatures of combustion requires significant adjustment in air/fuel/exhaust gas mixture provided to the engine by the ECT and is achievable with this invention. The ECT control system and methodology can also reduce Particulate Matter (PM) at transient engine operating points, increase low end torque, and assist in cold starting.

The ECT system provides significant reduction in engine emissions in many different operating modes of the engine. To achieve these reductions in emissions the ECT must be controlled according to the engines' speed and operators' torque demand. Therefore the strategies for implementing this control methodology are outlined below according to engine operational mode.

NOₓ reduction in steady state diesel engine operation has long been a target for engine developers and significant progress has been made in recent years with exotic after treatment solutions. Solutions, such as Selective Catalytic Reduction (SCR), are expensive to implement and require added chemicals which can potentially cause adverse consequences. A more efficient approach to reducing NOₓ is to increase EGR rates to cool down the combustion process into an area where NOₓ will not form. Cooling of the fresh charge and EGR are imperatively necessary to lower the combustion temperature and thus engine out emissions.

Typical turbocharged Compression Ignition Direct Injection (CIDI) Engines reduce NOₓ through EGR dilution. However, the amount of EGR which can be recirculated is limited by; loss of power, along with unacceptable transient behavior, and an increase in Particulate Matter (PM) emissions and BSFC brake specific fuel consumption. Part load Air/Fuel (A/F) ratio on those engines is widely uncontrolled, and thus, varies over a relatively large range.

The ECT system of the disclosed embodiment can be used in conjunction with the EGR Valve and Electronic Throttle to drastically increase EGR rates up to a theoretical 80% under steady state operation. These high EGR rates can be realized using the ECT system because of its ability to control both intake boost and exhaust back pressure to keep the A/F ratio optimal for PM emissions and fuel consumption.

The ECT assisted EGR dilution is explained below using the example of a 2 liter turbocharged CIDI engine operating at about 2000 rpm and at relatively low torque. The same concepts presented in this example can also be extended to larger Diesel engines.

In FIG. 2, three plots are shown in order to illustrate the why it is desirable to maintain an optimal A/F ratio throughout the operation of an engine. In graph “A”, the effects of varying the A/F ratio on the internal specific fuel consumption (“fuel efficiency”) is seen. In graph “B”, the effects of varying the A/F ratio on NOx emissions is seen. In graph “C”, the effects of varying the A/F ratio on PM is seen. From the collection of plotted graphs in FIG. 2, it can be seen that if one maintains an A/F ratio of approximately 2.7 (for this engine system example) the engine will generate the least amount of NOx and a low amount of PM while optimizing the fuel efficiency over the operating range of the engine. The ECT 210 is therefore operated in a way that will maintain the desired air/fuel mixture over that range.

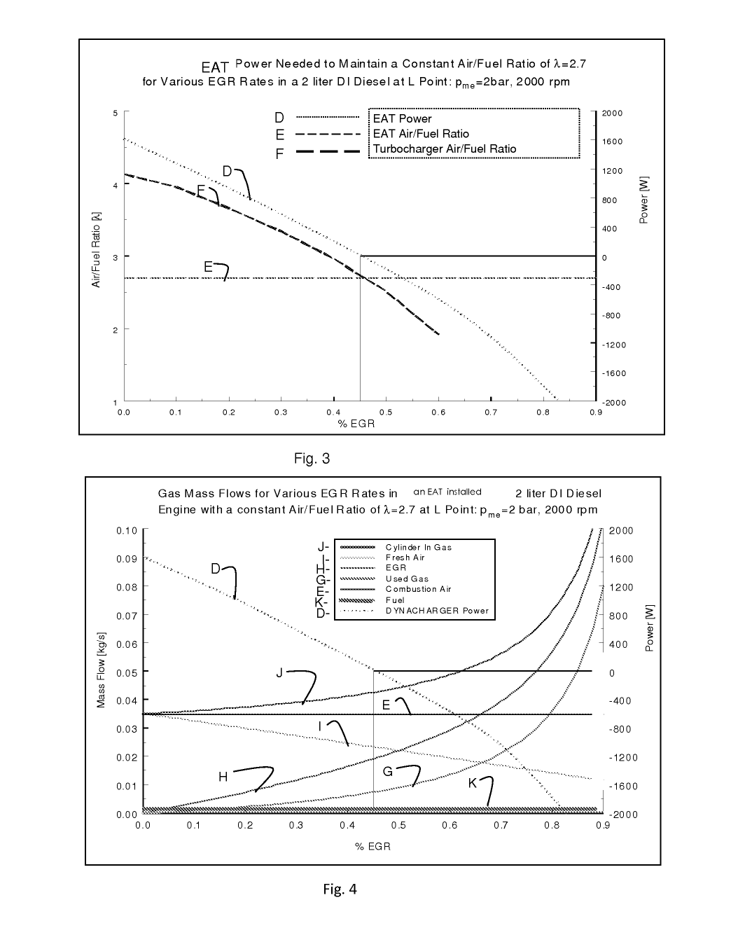

Graph “D” in FIG. 3 is a plot of the amounts of power that is extracted from the ETC and the power that is applied to the ECT in order to maintain a constant A/F ratio of 2.7 (selected for this example) versus a percentage of EGR (percentage of recirculated exhaust gas to the total combined mixture of the air/fuel mixture and recirculated exhaust gas input to the engine via the compressor of the ECT).

Graph “F” in FIG. 3 further shows that at the specific speed/load point of 2,000 rpm and 2 bar BMEP, a standard turbocharger will operate at the optimal 2.7 A/F ratio only at an EGR rate of ˜45%. If an ECT is used on the same engine, the optimal 2.7 A/F ratio can be achieved at EGR rates anywhere from 0% up to 80% by adjusting the amount of energy added or extracted from the electric motor on the turboshaft. Below 45% EGR, for instance, the ECT generates electrical energy due the turbine being driven by the exhaust gas from the engine. By adding a load to the ETC generator, the turbine is slowed down and the exhaust flow is adjusted to maintain the A/F ratio at the optimal 2.7. As EGR rates increase above 45% power is added to the ECT motor and the amount of exhaust gas diverted from the turbine increases. A standard turbocharger does not provide ample fresh air to support the combustion process at an optimal A/F ratio of 2.7. In the case of the disclosed embodiment, the ECT controller will provide electrical energy to the motor on the ETC and adjust the A/F ratio to 2.7.

FIG. 4 shows the different types of mass in the combustion cylinder of the engine 110 at various EGR rates and the corresponding ECT power Generation/Application level to achieve those EGR rates. The bullets below describe what each graph in FIG. 4 represents.
“D” represents the amount of ECT power generated/applied, as in FIG. 3.
“K” at the bottom represents the mass of fuel injected into the cylinder.
“E” represents the amount of combustion air in the cylinder, which corresponds to a constant A/F ratio.
“I” represents the amount of fresh air that enters the cylinder.
“G” represents the amount of inert gas which is recirculated through the LPL EGR system.
“H” represents the total mass of EGR passing through the LPL EGR system including both recirculated air and inert gas.
“J” represents the total amount of gas in the cylinder.

It will be noted that extremely high EGR rates 50%-80% can be achieved by the addition of electrical energy to the ECT. Plot G, which represents the amount of inert EGR for combustion process cooling, exponentially increases with the addition of ECT power. It is this high level of inert EGR which allows the high levels of NOₓ reduction which the ECT can provide in steady state operation.

The plots in FIG. 4 further serve to illustrate the relationships between the various combustion-gas elements that must be maintained in order to keep the A/F ratio optimal (in this example constant) over the operating range of the engine. For instance “J” (the gas in the cylinder) is the sum of “H” (the inert recirculated exhaust gas) and “I” (the fresh air). But basically, the relationships provide a road map for controlling the power to be extracted from the ETC or applied to the ETC in order to maintain an optimal A/F ratio and achieve the optimal fuel consumption, as well as relatively low NOx and PM emission levels that are superior for internal combustion engines.

The following describes how the ECT is used to increase the amount of EGR gases in the cylinder by depicting the various contributions of fuel, fresh air, excess lean air, recirculated air through EGR, and inert gas recirculated through EGR by rectangles representing their respective mass contributions in the cylinder. FIG. 5 is an example of such a representation with all the various components labeled. FIG. 5 is to be used as a guide in understanding the subsequent examples of EGR dilution scenarios. In FIG. 5, the lower set of three rectangles represent the stoichiometric mass of fresh air and fuel. The set of two rectangles immediately above the lower set of three represents the Fresh Air mass (from the air filter) of oxygen and nitrogen that are the first part of the air for the air/fuel mixture. The set of two rectangles above the Fresh Air represents the air which is recirculated with the exhaust gas and it is the second part of the combustion air for the air/fuel mixture.

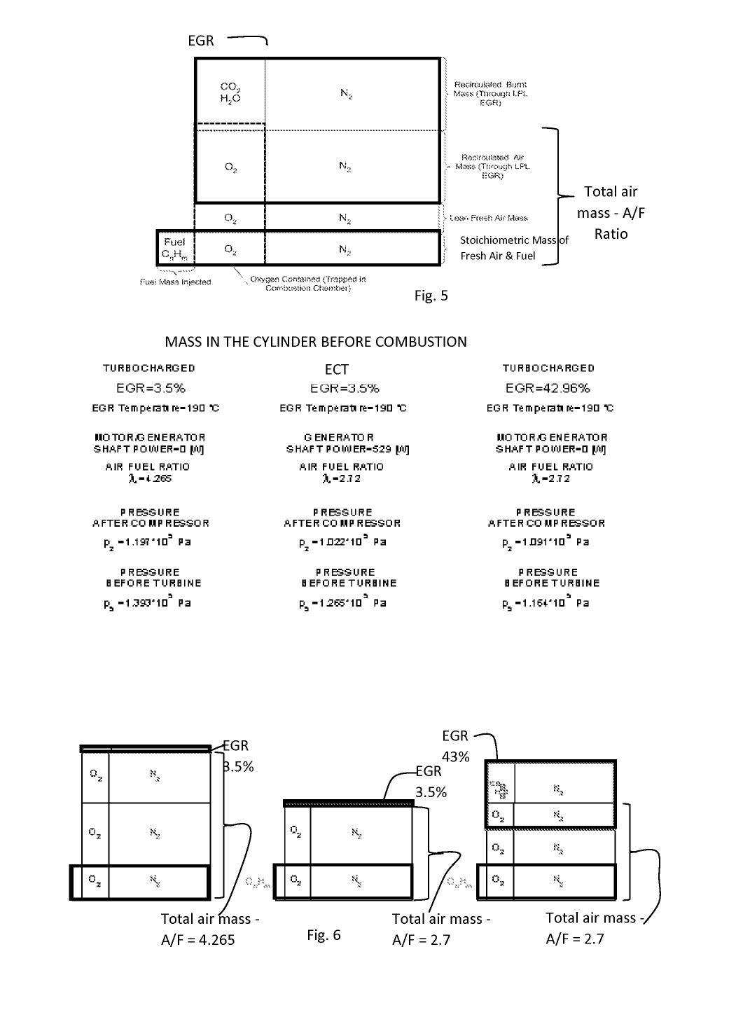

FIG. 6 below shows ECT and Standard Turbocharger Operation with Various Levels of EGR. The Calculations are based on 2 L DI-Diesel at 2 bar BMEP and 2,000 rpm. The same principals can be applied to larger diesel engines.

Rectangular boxes below each column of engine operating parameters represent the amounts of fresh air and re-circulated exhaust gas in the cylinder. Boxes labeled EGR represent the amount of EGR in the cylinder.

The first (left most) column shows the engine running with a standard turbocharger and 3.5% EGR. Notice that the A/F ratio is at 4.265 which is far too lean as compared with the optimal 2.7 for lowest fuel consumption.

The second (center) column shows how replacing the standard turbocharger with an ECT and slowing the turbocharger down by drawing power from the motor/generator the A/F ratio can be reduced to the optimal 2.7, while also generating 529 W of electrical energy.

The third column (right most) shows how the engine running with a standard turbocharger requires 43% EGR to reach the optimal fuel consumption A/F ratio of 2.7. Furthermore, when using the standard turbocharger, attempting to run higher rates of EGR will result in higher emissions and fuel consumption.

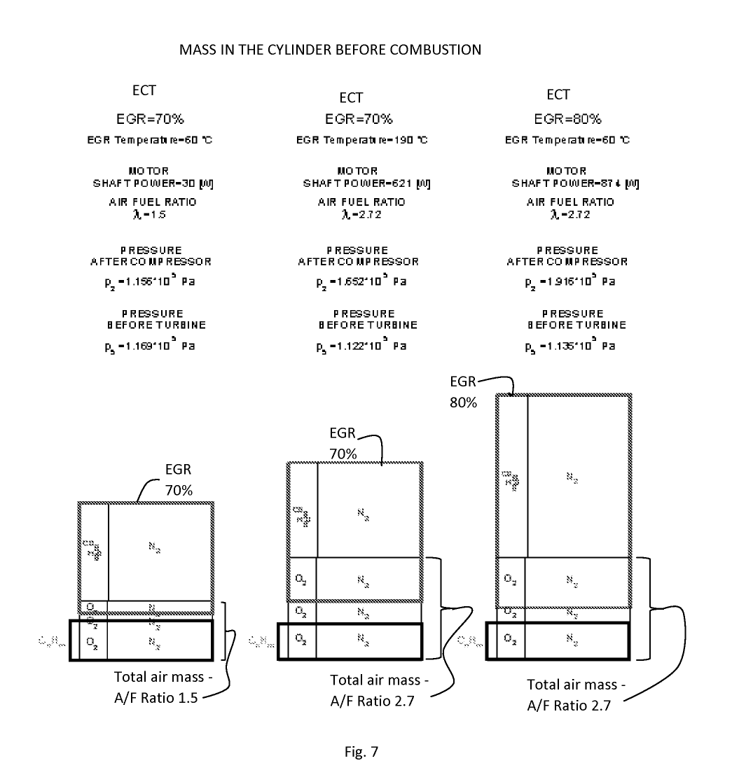

FIG. 7 shows how it is theoretically possible to run the engine at the same operating point with extremely high levels of EGR up to 80% while still maintaining the A/F ratio at 2.7 for optimal fuel consumption. Running this much EGR keeps the engine operating with very low NOₓ and PM emissions.

Conventional Diesel powered vehicles such as busses, delivery trucks, and garbage trucks commonly have high levels of PM and other emissions due to the fact that they are engaged in transient operations which involve high frequency of acceleration and deceleration driving schedules. This is because Diesel engines add excess fuel during transient operations to help spool up the turbocharger. A standard turbocharger cannot supply the correct amount of air to fully burn that fuel because it is limited by the fluid dynamics characteristics of its turbine and compressor design. Therefore the excess fuel simply exits the combustion chamber partially combusted into the exhaust stream in the form of PM and other harmful emissions. These emissions need to be removed by downstream devices such as Diesel Oxidation Catalysts (DOC), Particulate Matter filters (PM filters) and other after-treatment systems.

The ECT reduces the emissions leaving the combustion chamber under transient operation by adding electrical energy to the turbocharger to increase boost pressure. This added level of engine control enables the ECT to provide the correct amount of air to the cylinder and thereby reduce the amount of emissions introduced into the exhaust stream by the combustion process. Drastic reductions in PM emissions as high as 50% in pre-after-treatment emissions levels are achievable by the implementation of the ECT system in the transient operating mode.

Furthermore, more complete combustion of the fuel introduced to the combustion chamber as a result of the ECT providing the optimal A/F mixture will result in higher torque in transient operation. The vehicle operator will notice more power during acceleration periods all the while producing lower levels of emissions.

In engine cold start operation, Direct Injection Diesel Engines operate at compression ratios designed to ensure cold start, not for best efficiency (and not for lowest NOₓ Emissions). That is, the cold start requirements force compression ratios that are higher than otherwise needed and desired. DI Diesel Engines also require high rates of excess fuel to provide a “hydraulic gas seal” for the combustion chamber to generate the compression ratio required for cold start. The excess fuel causes elevated HC, CO, and PM emissions during cold start when the after treatment systems are not at operating temperatures.

Block heaters are also traditionally needed in colder climates to facilitate high enough cylinder inlet air temps for auto ignition to occur. The engine operator must wait for the block to heat up before attempting to start the vehicle.

The ECT adds compression by pre-boosting the engine intake air prior to engine cranking. Therefore the static compression ratio can be optimized for warm engine operation resulting in higher efficiency and reduced NOx. In addition, the boosted air has a higher temperature functioning like an inline air heater without the added complexity and therefore eases starting in cold climates. This effect can be significantly improved by recycling the compressed air several times though a throttle back to the compressor intake, before the engine is started.

Turbocharged Direct Injection Diesel Engines, even with state-of-the-art conventional turbochargers, are generally characterized by a severe lack of low-engine-speed power, that is, in the area where they need to operate most in US traffic. The underlying reason for this problem is the absence of sufficient exhaust gas energy to drive the turbocharger, further aggravated by the flow-restricting behavior of the turbocharger turbine. The problem has lead to unacceptable full load and part load acceleration as well as gradability. The only (very limited) remedy available to the vehicle driver is to predominantly drive in lower gears with a significant penalty in fuel consumption and noise.

Lower Brake Specific Fuel Consumption (BSFC) levels can be achieved if the vehicle can run in higher gears and hence lower engine speed. The added torque provided by ECT boost is what makes this implementation of down-speeding the engine possible thereby allowing lower fuel consumption levels.

The ECT can be used to overcome the deficiency in exhaust gas energy at low engine speeds by adding electrical energy to drive the turbocharger. The addition of electrical energy to the turbocharger can increase low-engine-speed full load power by approximately 38%. Also the ECT system can reduce low-engine-speed transient response by >50%. Of course to compensate for electrical parasitic losses in boosting at low engine speed, the ECT will generate electricity from exhaust gas energy at high speed and full load, and in certain part load areas.

The ECT LPL EGR Diesel system and methodology offer many benefits over existing technologies in its ability to allow extremely high EGR rates and consequential NOX reductions in steady state operation, assist and reduce emissions in engine cold start, and reduce PM emissions and increase performance in transient operation. This comprehensive approach to cleaning up the combustion process across the entire engine map places the technology in a class above even the most complex after treatment systems.

It is also important to note that the ECT LPL EGR Diesel system and methodology can be combined with other after treatment systems and modern turbocharging technologies such as Variable Geometry Turbomachinery (VGT) to provide even further reductions in emissions for Diesel Vehicles.

1. A method of controlling the operation of an internal combustion engine to achieve low NOx emissions and optimally low fuel consumption over the operating range of said engine comprising the steps of:
configuring said engine with an electrically assisted turbocharger having a turbine connected to a shaft and having said turbine connected to said engine to be driven by the exhaust gas exiting the exhaust port of said engine, a compressor connected to said shaft for supplying air and a portion of said exhaust gas to said the fresh air input port of said engine, and an electrically powered motor on said shaft for providing auxiliary power to said turbine and said compressor in response to electrical power;
providing a controller connected to said electrically powered motor of said electrically assisted turbocharger for regulating the amount of power applied to said motor in response to a plurality of input signals to maintain the air/fuel mixture within the combustion chamber of said engine at an optimal ratio for fuel consumption and NOx emissions.

2. A method as in claim 1, including the steps of providing an exhaust gas recirculation line from said exhaust port and providing an adjustable EGR valve to supply a portion of exhaust gas to said compressor and said controller is provided to adjust said EGR valve to controllably mix the appropriate portion of recirculated exhaust gas with air in said compressor to maintain the air/fuel mixture within the combustion chamber of said engine at an optimal ratio for fuel consumption and NOx emissions.

3. A method as in claim 1, further including the step of determining the optimal ratio of air/fuel mixture for said fuel consumption and NOx emissions

4. A method as in claim 3, wherein said controller is provided to maintain the air/fuel mixture within the combustion chamber of said engine at a substantially constant ratio that corresponds to the determined optimal ratio of air/fuel mixture.

5. A method as in claim 1, wherein said input signals are provided from an intake Air Mass Flowmeter.

6. A method as in claim 1, wherein said input signals are provided from an EGR Oxygen Sensor.

7. A method as in claim 1, wherein said input signals are provided from an EGR Cooler Differential Pressure Sensor.

8. A method as in claim 1, wherein said input signals are provided from a Driver Torque Command sensor.

9. A method as in claim 1, wherein said turbine, motor and compressor are mounted on a common shaft, and said controller performs the steps of applying electrical power to speed up said electrically powered motor, said turbine and said compressor mounted on said common shaft, and alternatively performs the steps of applying electrical load to lower the speed of said electrically powered motor, said turbine and said compressor mounted on said common shaft.

10. A method as in claim 8, wherein said controller performed steps are in response to signals from at least an intake air mass flow-meter, an exhaust gas recirculation oxygen sensor, and a driver torque command sensor.

11. A system for controlling the operation of an internal combustion engine comprising:
an electrically assisted turbocharger connected to said engine;
said turbocharger including a turbine connected to a shaft and said turbine connected to said engine to be driven by the exhaust gas exiting the exhaust port of said engine, a compressor connected to said shaft for supplying air to said the fresh air input port of said engine, and an electrically powered motor on said shaft for providing auxiliary power to said turbine and said compressor in response to electrical power applied to said motor;
a controller connected to said electrically powered motor of said electrically assisted turbocharger, wherein said controller receives a plurality of input signals and responsively regulates the amount of power applied to said motor to maintain the air/fuel mixture within the combustion chamber of said engine at a substantially constant predetermined ratio to achieve low NOx emissions and optimally low fuel consumption over the operating range of said engine.

12. A system as in claim 11, further including an exhaust gas recirculation line from said exhaust port and an adjustable EGR valve in said line to supply a portion of exhaust gas to said compressor;
said controller configured to adjust said EGR valve to controllably mix the appropriate portion of recirculated exhaust gas with air in said compressor to maintain the air/fuel mixture within the combustion chamber of said engine at a substantially constant predetermined ratio.

13. A system as in claim 11, wherein said turbine, motor and compressor are mounted on a common shaft, and said controller applies electrical power to speed up said electrically powered motor, said turbine and said compressor mounted on said common shaft, and alternatively applies electrical load to lower the speed of said electrically powered motor, said turbine and said compressor mounted on said common shaft.

14. A system as in claim 13, wherein said controller responds to signals from at least an intake air mass flow-meter, an exhaust gas recirculation oxygen sensor, and a driver torque command sensor.
